(19) United States
(12) Patent Application Publication
(10) Pub. No.: US 2022/0043801 A1
(43) Pub. Date: Feb. 10, 2022

(54) INFORMATION PROCESSING DEVICE, AND NON-TRANSITORY STORAGE MEDIUM

(71) Applicant: TOYOTA JIDOSHA KABUSHIKI KAISHA, Toyota-shi (JP)

(72) Inventors: Yusuke NAKADE, Nagoya-shi (JP); Ai MIYATA, Okazaki-shi (JP); Mitsuhiro MIURA, Okazaki-shi (JP); Shin SAKURADA, Toyota-shi (JP); Shuichi SAWADA, Nagoya-shi (JP); Satoshi KOMAMINE, Nagoya-shi (JP)

(73) Assignee: TOYOTA JIDOSHA KABUSHIKI KAISHA, Toyota-shi (JP)

(21) Appl. No.: 17/385,510

(22) Filed: Jul. 26, 2021

(30) Foreign Application Priority Data
Aug. 6, 2020 (JP) 2020-134111

(51) Int. Cl. G06F 16/23; G06F 21/62

(52) U.S. Cl. CPC G06F 16/2365; G06F 21/6245

(57) ABSTRACT

The present disclosure is aimed at increasing security of a system that provides mediation in a procedure for updating personal information that is registered. An information processing device includes a storage unit configured to store personal information data including pieces of personal information that are collected on a per-user basis. Furthermore, the information processing device includes a controller configured to: update at least a piece of the personal information that is stored, based on a request acquired from a user, receive, from the user, selection of a service provider to which the personal information after update is to be transmitted, receive, from the user, selection of the personal information that is to be transmitted to the service provider that is selected, and transmit the personal information that is selected to the service provider that is selected, to update the personal information registered with the service provider that is selected.

### CROSS REFERENCE TO THE RELATED APPLICATION

This application claims the benefit of Japanese Patent Application No. 2020-134111, filed on Aug. 6, 2020, which is hereby incorporated by reference herein in its entirety.

### BACKGROUND

### Technical Field

The present disclosure relates to a technique for supporting a user.

### Description of the Related Art

There is a technique for allowing an application to change registered information to be submitted collectively to a plurality of operators at a time when a part of personal information, such as a current address or a telephone number, is changed. For example, Patent Literature 1 discloses a system in which a device managing personal information submits an application to change registered information to a plurality of operators (such as a bank, a credit card company, and a post office; hereinafter such a system will be referred to as “collective application system”). According to the invention described in Patent Literature 1, the address and the like may be changed in a collective manner by specifying a plurality of operators.

### PATENT LITERATURE

### Patent Literature

Patent Literature 1: Japanese Patent Laid-Open No. 2004-013428

### SUMMARY

According to the conventional technique, personal information after change may be transmitted to each operator by a simple operation. However, it is conceivable that, in the future, not only addresses and telephone numbers, but also various pieces of personal information including financial information and credit information will be handled online. In a case where the collective application system handles such sensitive information, such information is possibly also transmitted to outside by a simple operation, and there is a concern over security.

The present disclosure is aimed at increasing security of a system that provides mediation in a procedure for updating personal information that is registered.

An information processing device according to a first aspect of the present disclosure may include a storage configured to store personal information data including pieces of personal information that are collected on a per-user basis; and a controller configured to update at least a piece of the personal information that is stored, based on a request acquired from a user, receive, from the user, selection of a service provider to which the personal information after update is to be transmitted, receive, from the user, selection of the personal information that is to be transmitted to the service provider that is selected, and transmit the personal information that is selected to the service provider that is selected, to update the personal information registered with the service provider that is selected.

Furthermore, an information processing device according to a second aspect of the present disclosure may include a controller configured to: receive, from a user changing at least one of a plurality of pieces of personal information, selection of a service provider to which the personal information after change is to be transmitted, receive, from the user, selection of the personal information to be transmitted to the service provider that is selected, and transmit the personal information that is selected to the service provider that is selected, to update the personal information registered with the service provider that is selected.

Furthermore, a non-transitory storage medium according to a third aspect of the present disclosure may store a program for causing a computer to: receive, from a user changing at least one of a plurality of pieces of personal information, selection of a service provider to which the personal information after change is to be transmitted, receive, from the user, selection of the personal information to be transmitted to the service provider that is selected, and transmit the personal information after change that is selected to the service provider that is selected, to update the personal information registered with the service provider that is selected.

Furthermore, as another aspect, there may be cited a method that is performed by the information processing device described above, or a non-transitory computer-readable storage medium storing the program described above.

According to the present disclosure, security may be increased for a system that provides mediation in a procedure for updating personal information that is registered.

### BRIEF DESCRIPTION OF THE DRAWINGS

FIG. 1 is a diagram for describing an outline of an application intermediary system;

FIG. 2 is a diagram illustrating in detail structural elements of the application intermediary system according to a first embodiment;

FIG. 3 is a diagram illustrating relationships among modules of the first embodiment;

FIG. 4 is a diagram for describing personal information data that is stored in a storage unit;

FIG. 5 is a diagram for describing handled item data that is stored in the storage unit;

FIG. 6 is a flowchart illustrating a flow of data transmitted and received in a first phase;

FIG. 7 is an example of a screen for updating registered information;

FIG. 8 is a flowchart illustrating a flow of data transmitted and received in a second phase;

FIG. 9 is an example of a screen for selecting a service provider;

FIG. 10 is an example of a screen for selecting information to be transmitted to a service provider; and

FIG. 11 is a diagram illustrating relationships among modules of a second embodiment.

### DESCRIPTION OF THE EMBODIMENTS

There is a system that allows a request to change registered information to be made to a plurality of operators in a collective manner when a part of personal information, such as a current address or a telephone number, is changed. A procedure to change the address or the like may thus be easily taken in relation to a bank, a post office, an electric power company, an Internet service provider and the like, for example.

In the future, not only addresses and telephone numbers, but various pieces of personal information will be expected to be handled online. For example, it is conceivable that information about income and personal credit information will be managed in a centralized manner, and contract of loan, insurance or the like will be completed online.

In a case where the system described above stores such personal information, sensitive personal information is possibly transmitted to outside without attracting user's sufficient attention.

An information processing device according to the present embodiment may include a storage unit configured to store personal information data including pieces of personal information that are collected on a per-user basis; and a controller configured to update at least a piece of the personal information that is stored, based on a request acquired from a user, receive, from the user, selection of a service provider to which the personal information after update is to be transmitted, receive, from the user, selection of the personal information that is to be transmitted to the service provider that is selected, and transmit the personal information that is selected to the service provider that is selected, to update the personal information registered with the service provider that is selected.

The personal information data is a collection of pieces of personal information including a name, an address and a telephone number, for example. The personal information data may include sensitive data such as information about finance, information about personal credit and the like.

The service provider is a business entity holding the personal information on a user. For example, the service provider holds the personal information on a user in the form of membership information, customer information or the like.

The service provider may be a public organization or a for-profit organization as long as the service provider provides services to users. For example, the service provider may be an autonomous body, a governmental body, a bank, a post office, a communications company, an electric power company, a network operator, an electronic commerce operator (an EC site) and the like.

A user has an individual contract with the service provider and, when the personal information is changed, registered personal information (hereinafter “registered information”) has to be updated. The information processing device according to the present embodiment may be a device that takes care of such a procedure.

To update the personal information registered with each service provider, the information processing device may transmit personal information on a type that is selected by the user, to a service provider that is selected by the user.

For example, the information processing device may allow such selection to be performed by providing, in relation to the service provider for which a procedure is desired by the user to be performed, information indicating which personal information is being held and which personal information is to be transmitted.

According to such a configuration, a user may be allowed to select information that is to be transmitted to a plurality of service providers and information that is not to be transmitted, and the user may grasp the type of information that is transmitted to outside.

Furthermore, the storage unit may further store first data associating the user and at least one service provider.

The service provider where the personal information is to be updated may be specified for each user by referring to the first data.

Furthermore, the storage unit may further store second data associating the service provider and a type of the personal information that is registered with the service provider.

The second data may be data indicating which personal information is held by each service provider. The type of personal information that is to be transmitted may be specified for each service provider by referring to the second data.

Furthermore, the controller may create a list of service providers to which the personal information after update is to be transmitted, based on the type of the personal information that is updated, the first data and the second data.

According to such a configuration, a list of service providers where information has to be updated may be presented to the user.

Furthermore, the controller may create a user interface for selecting the personal information that is to be transmitted to the service provider that is selected.

Furthermore, the controller may create a user interface for selecting, from among a plurality of pieces of the personal information included in the personal information data, the personal information that is to be transmitted to the service provider that is selected.

For example, the user interface may be a screen on which an item corresponding to the personal information that is to be transmitted to the service provider is selected. Selection of the personal information may be performed using a checkbox, for example. An item to be transmitted and an item not to be transmitted, among a plurality of pieces of personal information, may thus be visualized.

Furthermore, the controller may create the user interface where the personal information that is registered with the service provider that is selected is selected by default.

Furthermore, the controller may create the user interface where the personal information that is required to be provided to the service provider that is selected is selected by default.

According to such a configuration, an item that is to be transmitted to a selected service provider may be visualized.

Furthermore, the controller may determine a type of the personal information that is required to be provided, based on a category of the service provider.

This allows handling of cases in the manner of “transmit individual number of a user when the category is ‘governmental’” and “do not transmit information about assets of a user when the category is not ‘financial’”, for example.

Furthermore, the controller may detect a change in the personal information corresponding to the user, based on a result of performing sensing regarding the user.

Furthermore, the personal information that is a target of update may be a current address, and the controller may detect a change in a residence of the user, based on a result of sensing position information on the user.

In the case where a change in the personal information is detected, the user may be urged to update the personal information data. This allows the personal information data stored in the device to be appropriately updated.

Furthermore, the controller may further authenticate the user, and authentication data indicating an authentication result may be transmitted to the service provider, together with the personal information that is updated.

According to such a configuration, it can be made clear to the service provider that a procedure for changing the personal information is performed with the consent of the user.

In the following, embodiments of the present disclosure will be described with reference to the drawings. Configurations of the following embodiments are merely examples, and the present disclosure is not limited to the configurations of the embodiments.

### First Embodiment

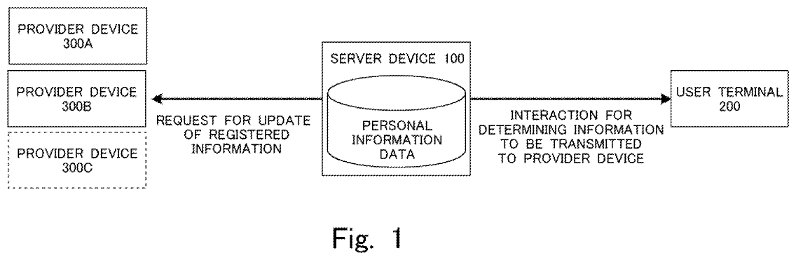

An outline of an application intermediary system according to a first embodiment will be given with reference to FIG. 1. The application intermediary system according to the present embodiment includes a plurality of provider devices 300A, 300B, and so on associated with a plurality of service providers, respectively, a user terminal 200 that is a terminal used by a user, and a server device 100.

The provider device 300 is a device that is associated with a service provider that holds personal information on the user. The service provider is a business entity that provides services to users, and may be an autonomous body, a bank, a post office, a communications company, an electric power company, an Internet service provider, or an electronic commerce operator (an EC site), for example. The provider device 300 holds personal information on the user in the form of membership information or customer information, for example.

Additionally, there may be a plurality of provider devices 300. In the present embodiment, a plurality of provider devices (300A, 300B, . . . ) are collectively referred to as “provider device(s) 300”.

The user terminal 200 is a computer used by the user to access the server device 100.

The server device 100 is a device that manages the personal information on the user. The server device 100 updates personal information data of the user based on a request transmitted from the user terminal 200. Furthermore, the server device 100 requests the provider device 300 to update registered information (such as the membership information or the customer information) based on a result of interacting with the user terminal 200.

Additionally, in the example in FIG. 1, the server device 100 is associated with the user terminal 200 in a one-to-one manner, but instead, one server device 100 may be in charge of a plurality of user terminals 200.

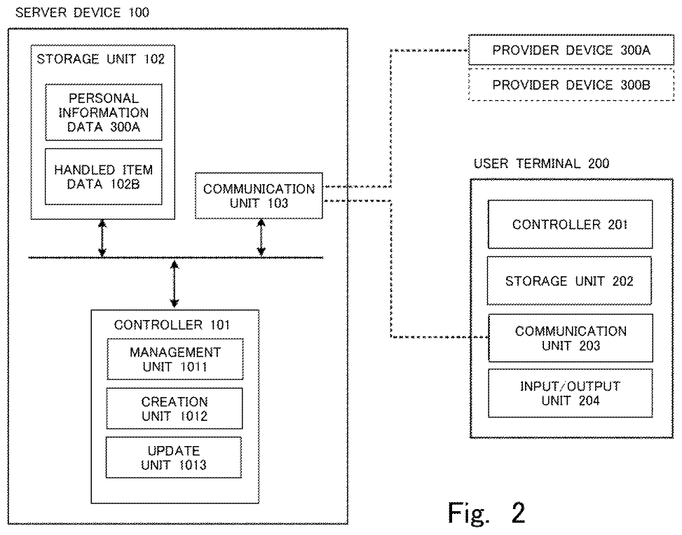

FIG. 2 is a diagram illustrating in greater detail structural elements of the application intermediary system according to the present embodiment. First, a description of the user terminal 200 will be given.

For example, the user terminal 200 is a small computer such as a smartphone, a mobile phone, a tablet computer, a personal digital assistant, a laptop computer, or a wearable computer (such as a smartwatch). The user terminal 200 includes a controller 201, a storage unit 202, a communication unit 203, and an input/output unit 204.

The controller 201 is an arithmetic device that is in charge of control that is performed by the user terminal 200. The controller 201 may be implemented by an arithmetic processing device such as a central processing unit (CPU).

Each function described later may be implemented by the CPU executing a program stored in the storage unit 202 described later.

The controller 201 implements a function of accessing and interacting with the server device 100. In the present embodiment, this function is implemented by a web browser operating on the user terminal 200. A specific method will be described later.

The storage unit 202 includes a main memory and an auxiliary memory. The main memory is a memory where programs to be executed by the controller 201 and data to be used by the control programs are developed. The auxiliary memory is a device where the programs to be executed by the controller 201 (such as the web browser) and data to be used by the programs are stored. The auxiliary memory may store the programs to be executed by the controller 201 in the form of packaged applications. Furthermore, an operating system for executing such applications may also be stored. Processes described later are performed by the programs stored in the auxiliary memory being loaded into the main memory and executed by the controller 201.

The main memory may include a random access memory (RAM) and a read only memory (ROM). Furthermore, the auxiliary memory may include an erasable programmable ROM (EPROM) and a hard disk drive (HDD). The auxiliary memory may further include a removable medium, or in other words, a removable recording medium. The removable medium is a universal serial bus (USB) memory, or a disc recording medium such as a compact disc (CD) or a digital versatile disc (DVD), for example.

The communication unit 203 is a wireless communication interface for connecting the user terminal 200 to the server device 100. For example, the communication unit 203 is capable of communicating with the server device 100 by a wireless LAN or a mobile communication service such as 3G, LTE and 5G.

The input/output unit 204 is a unit that receives an input operation performed by the user, and that presents information to the user, and is, in the present embodiment, one touch panel display. That is, a liquid crystal display and control means thereof, or a touch panel and control means thereof are used therefor.

Additionally, the configuration illustrated in FIG. 2 is merely an example, and one or some or all of the functions illustrated may be executed by a circuit that is dedicatedly designed. Furthermore, programs may be stored and executed by a combination of a main memory and an auxiliary memory other than those illustrated in the drawing.

Next, a description will be given of the server device 100.

The server device 100 is a computer that manages personal information on a plurality of users.

Furthermore, in a case where the personal information on a user is updated, the server device 100 requests a plurality of service providers (the provider devices 300) to update the registered information, based on a request from the user.

The server device 100 may be a general-purpose computer. That is, the server device 100 may be a computer that includes processors such as a CPU and a GPU, main memories such as a RAM and a ROM, and auxiliary memories such as an EPROM, a hard disk drive and a removable medium. Additionally, the removable medium may be an USB memory or a disc recording medium such as a CD and a DVD, for example. The auxiliary memory stores an operating system (OS), various programs, various tables and the like, and a function matching a predetermined object as described later may be implemented by loading a program that is stored in the auxiliary memory into a work area of the main memory and executing the program, and controlling each structural unit through execution of the program. However, one or some or all of the functions may alternatively be implemented by a hardware circuit such as an ASIC and an FPGA.

A controller 101 is an arithmetic device that is in charge of control that is performed by the server device 100. The controller 101 may be implemented by an arithmetic processing device such as a CPU.

The controller 101 includes three functional modules, namely, a management unit 1011, a creation unit 1012, and an update unit 1013. Each functional module may be implemented by the CPU executing a stored program.

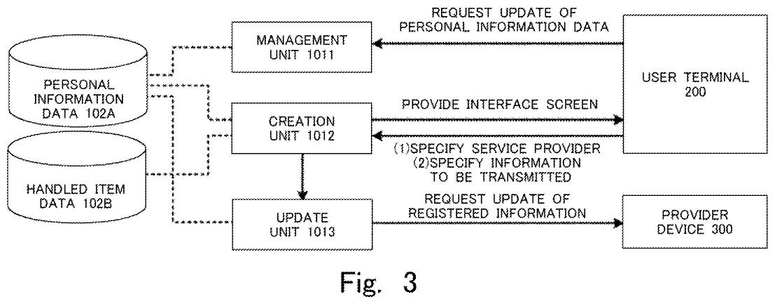

The three functional modules will be described with reference to FIG. 3 that is a diagram illustrating data that is transmitted/received among the modules.

The management unit 1011 receives, from the user terminal 200, a request to update personal information data stored in a storage unit 102, described later, and updates the personal information data based on the request.

Based on a result of interacting with the user terminal 200, the creation unit 1012 determines (1) to which service provider (provider device 300) the request to update the registered information is to be transmitted, and (2) which of items included in the personal information data is to be transmitted to each provider device 300 to request update of the registered information.

The update unit 1013 creates an update request including the item determined by the creation unit 1012, and transmits the same to the provider device 300 that is the target.

The storage unit 102 includes a main memory and an auxiliary memory. The main memory is a memory where programs to be executed by the controller 101 and data to be used by the control programs are developed. The auxiliary memory is a device where the programs to be executed by the controller 101 and data to be used by the control programs are stored.

The storage unit 102 stores personal information data 102A and handled item data 102B.

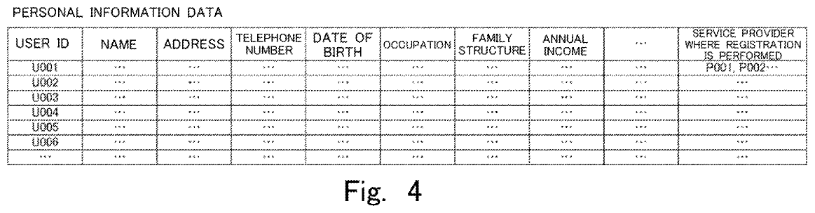

The personal information data 102A is a collection of personal information on a user who uses the system. FIG. 4 is an example of the personal information data 102A.

In the present embodiment, a plurality of items such as a name, an address, a telephone number, and a date of birth are stored in association with an identifier of the user (a user ID), for example.

Furthermore, an identifier of a service provider where information about each user is registered is stored in association in the personal information data 102A. In a case where there is a user who changed a part of the personal information, which service provider is to be requested to update the registered information may be determined by referring to the personal information data 102A.

Additionally, in the present embodiment, each of a plurality of items included in the personal information data will be referred to as “personal information item” or simply as “item”.

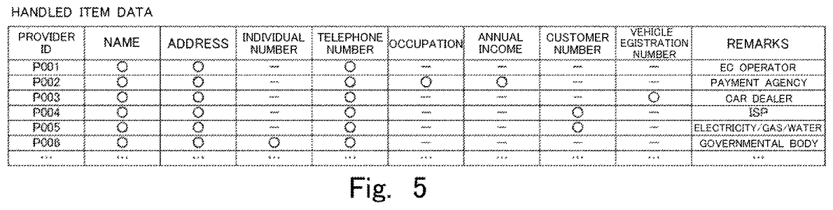

The handled item data 102B is data indicating, for each service provider, the personal information item that is being held. FIG. 5 is an example of the handled item data 102B.

For example, in the illustrated example, it is indicated that a service provider (for example, an EC operator) having an identifier “P001” holds “name”, “address”, and “telephone number”. Furthermore, it is indicated that a service provider (for example, an electric power company) having an identifier “P005” holds “name”, “address”, “telephone number”, and “customer number”. Furthermore, it is indicated that a service provider (for example, a governmental body) having an identifier “P006” holds “name”, “address”, “individual number”, and “telephone number”.

In the case of requesting a service provider to update the registered information, an item to be transmitted to the service provider may be determined by referring to the handled item data 102B.

Like the communication unit 203, a communication unit 103 is a communication interface. For example, the communication unit 103 is capable of communicating with the user terminal 200 via a wide area network such as the Internet.

Next, a process that is performed by the server device 100 will be described. The server device 100 updates the stored personal information data based on a first request acquired from the user terminal 200. Furthermore, the server device 100 requests a service provider to update the registered information, based on a second request acquired from the user terminal 200. The former will be referred to as a first phase, and the latter as a second phase.

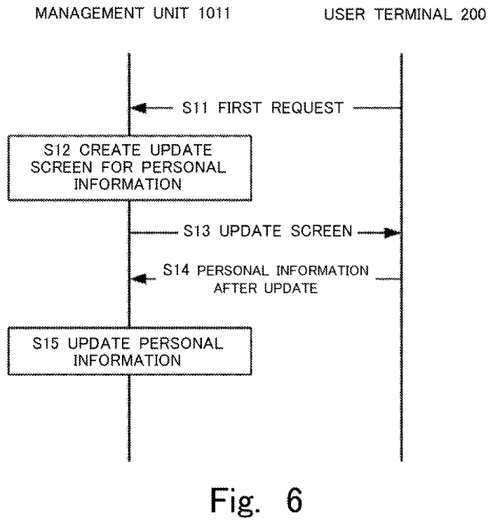

FIG. 6 is a flowchart illustrating a flow of data transmitted and received between the devices in the first phase.

First, in step S11, the user terminal 200 transmits, to the server device 100 (the management unit 1011), a request (a first request) to update the personal information data that is stored in the server device 100.

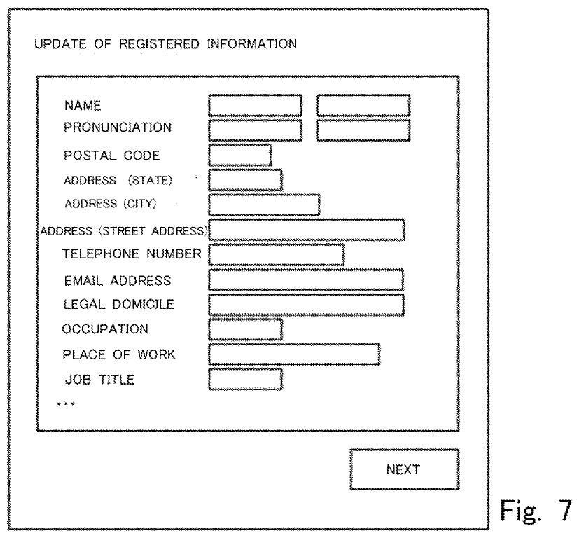

When the first request is received, the management unit 1011 extracts, in step S12, a plurality of personal information items corresponding to the user from the personal information data 102A, and creates a user interface (a screen) for updating the items. FIG. 7 is an example of a screen that is created by the management unit 1011. The screen may be created using HTML or CSS, for example.

In step S13, the management unit 1011 transmits the created screen to the user terminal 200. A user interface screen is thus displayed on the user terminal 200.

When the user inputs the personal information on the screen, data after update is transmitted to the server device 100 (step S14).

Then, the management unit 1011 updates item(s) included in the personal information data 102A based on the received data (step S15).

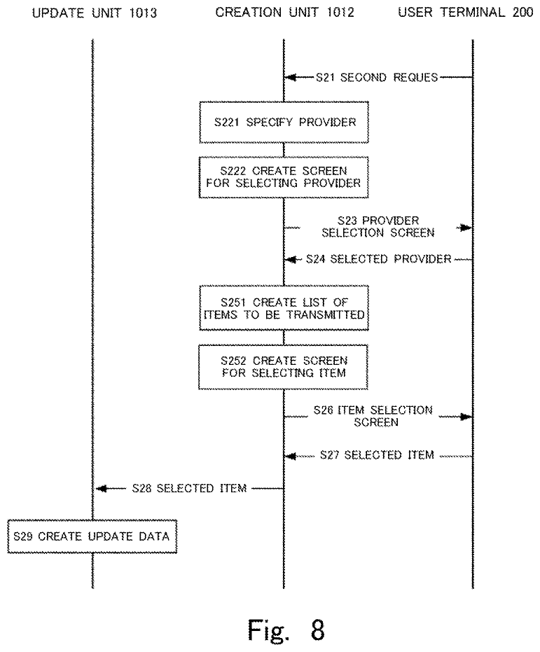

FIG. 8 is a flowchart illustrating a flow of data transmitted and received between the devices in the second phase.

First, in step S21, the user terminal 200 transmits, to the server device 100 (the creation unit 1012), a request (a second request) to update the personal information that is registered with the service provider.

When the second request is received, the creation unit 1012 refers to the personal information data 102A in step S221, and specifies the service provider that is entrusted with the personal information by the user who is a transmission source of the request. For example, in the example in FIG. 4, a record is searched for with a user ID as a key, and the ID of the service provider with which the corresponding user is registered is acquired. Here, a plurality of service providers may be specified.

Additionally, the list that is created in step S221 may be a list of all the service providers that are entrusted with the personal information by the user, or may be a list including only the service providers, among all the service providers, that hold the personal information item updated in the first phase. This is because it is not necessary to request a service provider holding only the personal information items that are not updated to update the registered information.

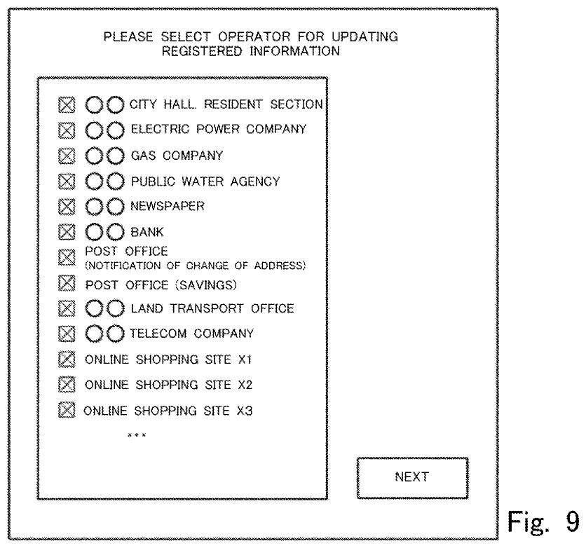

In step S222, the creation unit 1012 creates a user interface (screen) for selecting a service provider. FIG. 9 is an example of a screen that is created by the creation unit 1012. As illustrated in the drawing, the creation unit 1012 creates a screen including the list of service providers and elements (such as checkboxes) for selecting respective service providers. Additionally, the method of selection is not limited to that using checkboxes as long as the personal information item to be provided to a selected service provider may be selected.

In step S23, the creation unit 1012 transmits the created screen to the user terminal 200. A user interface screen is thus displayed on the user terminal 200.

When the user performs an operation of selecting a service provider on the screen, data about the selected service provider is transmitted to the server device 100 (step S24).

In step S251, the creation unit 1012 creates, for each selected service provider, a list of personal information items to be transmitted to the service provider.

The personal information items to be transmitted to the service provider may be a set of personal information items held by the service provider, for example, or may alternatively be a set of personal information items required to be provided to the service provider, a set of personal information items updated by the user and not yet transmitted to the service provider, or a combination thereof.

For example, in a case where a service provider holding “name”, “address”, and “telephone number” is selected and only the telephone number is updated, a list including only “telephone number” may be created, or a list including “name”, “address”, and “telephone number” may be created.

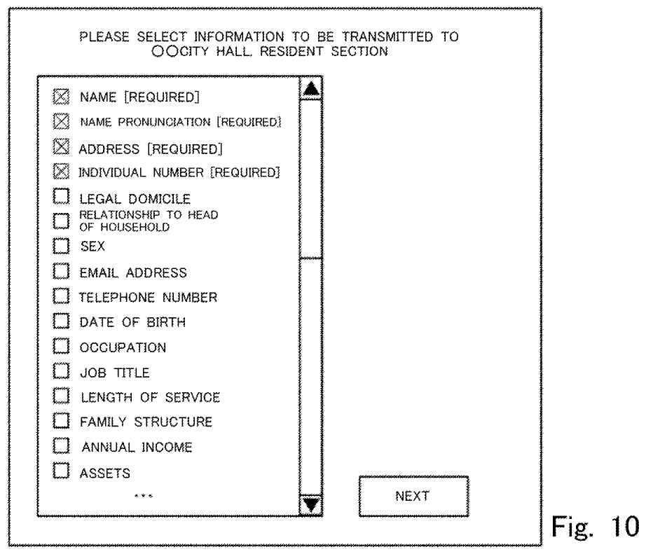

Next, in step S252, the creation unit 1012 creates a screen for selecting the personal information item(s) to be transmitted to the service provider, based on the created list. FIG. 10 is an example of a screen that is created. In the present example, all the personal information items held by the server device 100 are displayed, and items to be transmitted to the selected service providers are marked (by a display of “required”, for example). Additionally, in the present example, items to be transmitted are selected by default, but selection may alternatively be performed by the user.

The user may thus grasp which item(s) among the personal information managed by the server device 100 is/are to be transmitted to the selected service provider.

In step S26, the creation unit 1012 transmits the created screen to the user terminal 200. A user interface screen is thus displayed on the user terminal 200.

When the user performs an operation of selecting the personal information item on the screen, data about the selected item is transmitted to the server device 100 (step S27). The selected item is transmitted to the update unit 1013 in step S28.

In step S29, the update unit 1013 extracts the personal information item selected by the user, from the personal information data 102A, and creates data (update data) for requesting update of the item. The update data includes the personal information item after update. The created update data is transmitted to the provider device 300 corresponding to the selected service provider.

Additionally, in a case where a plurality of service providers are selected by the user, processes in steps 5251 to S29 may be repeated. Alternatively, the process in step S251 may be performed for each service provider, and a user interface may be created in step S252 that allows selection of items for the plurality of service providers to be performed on one screen.

As described above, with the application intermediary system according to the first embodiment, which of a plurality of personal information items is to be transmitted and which is not to be transmitted may be made clear at a time of requesting a service provider associated with a user to update the registered information; that is, appropriate handling of sensitive information is enabled.

(Modification of First Embodiment)

In the first embodiment, the personal information item to be provided to a service provider is determined based only on the handled item data 102B, but the personal information item to be transmitted to a service provider may be determined by also using the category of the service provider.

For example, in a case where the service provider is not related to finance or insurance, there is no possibility of annual income, financial assets, credit information and the like of a user being handled. Furthermore, in a case where the service provider is not related to a vehicle, there is no possibility of registration number (license plate number) and the like of a vehicle being handled. On the other hand, in a case where the service provider provides mediation in matching users, information about annual income, family structure and the like is possibly required.

Accordingly, it is possible to set in advance whether to provide each of a plurality of personal information items or not, based on the category of the service provider. By filtering items that do not need to be provided, a sense of security may be provided to the user.

### Second Embodiment

In the first embodiment, the user himself/herself updates the personal information that is stored in the server device 100. In contrast, a second embodiment is an embodiment in which a change in the personal information on a user is detected by the system.

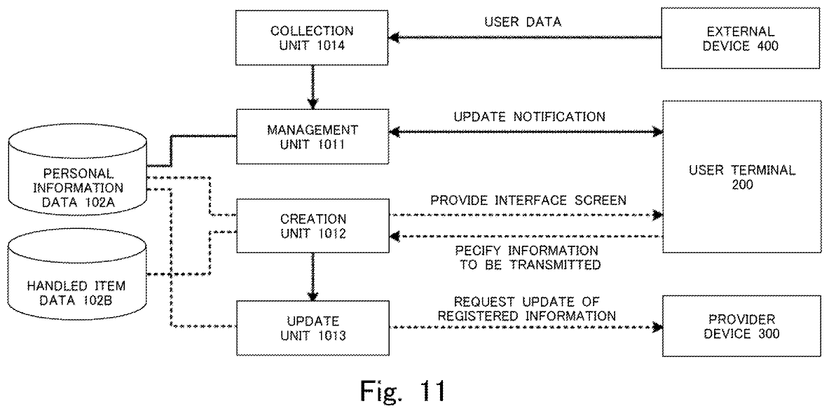

In the second embodiment, the controller 101 further includes a collection unit 1014. FIG. 11 is a diagram illustrating relationships among modules of the second embodiment.

The collection unit 1014 collects data about the state of a user (hereinafter “user data”) from an external device 400 that is a device that collects the user data.

For example, the user data may be information that is obtained by performing sensing regarding the user. For example, in a case where the external device 400 is a sensing device installed at home of the user, the server device 100 may detect a change in the family structure of the user based on a result of sensing. The sensing device may be a sensor that acquires images, or a smart speaker that collects audio, for example.

Furthermore, the user data may be data that is provided by a public organization. For example, in a case where the external device 400 is a server device that belongs to a public organization, certificate-of-residence data may be acquired as the user data. The server device 100 may thus detect a change in the address or the like of the user.

Moreover, the user data may be position information on the user terminal 200. In this case, the external device 400 and the user terminal 200 may be a same device. The server device 100 may thus detect a change in the residence or in the place of work of the user based on a record of position information that is collected.

Furthermore, the user data may be telephone number information held by the user terminal 200. In this case, the server device 100 may detect a change in the mobile phone number of the user.

The user data collected by the collection unit 1014 is transmitted to the management unit 1011, and the management unit 1011 detects a change in the personal information on the user. Then, the management unit 1011 updates the personal information data 102A as necessary. Additionally, at this time, the management unit 1011 may interact with the user terminal 200 to notify the user that update is performed.

Furthermore, the personal information does not have to be automatically updated. In this case, the management unit 1011 may prompt the user terminal 200 to update the personal information data.

According to the second embodiment, that the personal information on a user is partially changed may be detected, and the personal information data 102A may be appropriately updated.

(Modification)

The embodiments described above are merely examples, and the present disclosure may be changed as appropriate within the scope of the disclosure.

For example, processes and means described in the present disclosure may be freely combined to the extent that no technical conflict exists.

Furthermore, in the description of the embodiments, the update unit 1013 transmits the update data to the provider device 300, and the update data may further include data for authenticating the user. For example, at the time of receiving the first request in step S11, the server device 100 may authenticate the user terminal 200, and the data acquired at this time (data for authenticating the user) may be included in the update data. The service provider may thus be informed that the procedure for changing the personal information is performed with the consent of the user.

Furthermore, in the description of the embodiments, a mode is described where the server device 100 holds the personal information data, but the personal information data may alternatively be stored outside the server device 100. That is, the server device 100 may perform only the process of selecting information to be provided to a service provider.

Furthermore, a process that is described to be performed by one device may be shared and performed by a plurality of devices. Processes described to be performed by different devices may be performed by one device. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical discs (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. An information processing device comprising:
a storage configured to store personal information data including pieces of personal information that are collected on a per-user basis; and
a controller configured to:
update at least a piece of the personal information that is stored, based on a request acquired from a user,
receive, from the user, selection of a service provider to which the personal information after update is to be transmitted,
receive, from the user, selection of the personal information that is to be transmitted to the service provider that is selected, and
transmit the personal information that is selected to the service provider that is selected, to update the personal information registered with the service provider that is selected.

2. The information processing device according to claim 1, wherein the storage further stores first data associating the user and at least one service provider.

3. The information processing device according to claim 2, wherein the storage further stores second data associating the service provider and a type of the personal information that is registered with the service provider.

4. The information processing device according to claim 3, wherein the controller creates a list of service providers to which the personal information after update is to be transmitted, based on the type of the personal information that is updated, the first data and the second data.

5. The information processing device according to claim 3, wherein the controller creates a user interface for selecting the personal information that is to be transmitted to the service provider that is selected.

6. The information processing device according to claim 3, wherein the controller creates a user interface for selecting, from among a plurality of pieces of the personal information included in the personal information data, the personal information that is to be transmitted to the service provider that is selected.

7. The information processing device according to claim 5, wherein the controller creates the user interface where the personal information that is registered with the service provider that is selected is selected by default.

8. The information processing device according to claim 5, wherein the controller creates the user interface where the personal information that is required to be provided to the service provider that is selected is selected by default.

9. The information processing device according to claim 8, wherein the controller determines a type of the personal information that is required to be provided, based on a category of the service provider.

10. The information processing device according to claim 1, wherein the controller detects a change in the personal information corresponding to the user, based on a result of performing sensing regarding the user.

11. The information processing device according to claim 10, wherein
the personal information that is a target of update is a current address, and
the controller detects a change in a residence of the user, based on a result of sensing position information on the user.

12. The information processing device according to claim 1, wherein
the controller further authenticates the user, and authentication data indicating an authentication result is transmitted to the service provider, together with the personal information that is updated.

13. An information processing device comprising a controller configured to:
receive, from a user changing at least one of a plurality of pieces of personal information, selection of a service provider to which the personal information after change is to be transmitted,
receive, from the user, selection of the personal information to be transmitted to the service provider that is selected, and
transmit the personal information that is selected to the service provider that is selected, to update the personal information registered with the service provider that is selected.

14. The information processing device according to claim 13, further comprising a storage configured to store data associating the service provider and a type of the personal information that is registered with the service provider.

15. The information processing device according to claim 14, wherein the controller creates a user interface for selecting, from among the plurality of pieces of personal information, the personal information that is to be transmitted to the service provider that is selected.

16. The information processing device according to claim 15, wherein the controller creates the user interface where the personal information that is registered with the service provider that is selected is selected by default.

17. The information processing device according to claim 13, wherein
the controller further authenticates the user, and
authentication data indicating an authentication result is transmitted to the service provider, together with the personal information that is changed.

18. A non-transitory storage medium storing a program for causing a computer to:
receive, from a user changing at least one of a plurality of pieces of personal information, selection of a service provider to which the personal information after change is to be transmitted,
receive, from the user, selection of the personal information to be transmitted to the service provider that is selected, and
transmit the personal information that is selected to the service provider that is selected, to update the personal information registered with the service provider that is selected.

19. The non-transitory storage medium according to claim 18, wherein the program causes the computer to acquire data associating the service provider and a type of the personal information that is registered with the service provider.

20. The non-transitory storage medium according to claim 18, wherein the program causes the computer to create a user interface for selecting the personal information that is to be transmitted to the service provider that is selected.
